(19) United States
(12) Patent Application Publication
(10) Pub. No.: US 2009/0171665 A1
(43) Pub. Date: Jul. 2, 2009

(54) METHOD AND APPARATUS FOR CREATING AND MODIFYING NAVIGATION VOICE SYNTAX

(75) Inventors: Scott D. Hammerschmidt, Eudora, KS (US); Jacob W. Caire, Olathe, KS (US); Michael P. Russell, Overland Park, KS (US); David W. Wiskur, Olathe, KS (US); Scott J. Brunk, Edgerton, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., Camana Bay (KY)

(21) Appl. No.: 12/338,681

(22) Filed: Dec. 18, 2008

Related U.S. Application Data
(60) Provisional application No. 61/017,218, filed on Dec. 28, 2007.

(51) Int. Cl. G10L 13/00

(52) U.S. Cl. 704/258; 704/E13.008

(57) ABSTRACT

Techniques are described for enabling flexible and dynamic creation and/or modification of voice data for a position-determining device. In some embodiments, a voice package is provided that includes a language database and a plurality of audio files. The language database specifies appropriate syntax and vocabulary for information that is intended for audio output by a position-determining device. The audio files include words and/or phrases that may be accessed by the position-determining device to communicate the information via audible output. Some embodiments utilize a voice package toolkit to construct and/or customize one or more parts of a voice package.

### RELATED APPLICATIONS

This Application claims the benefit of and priority to U.S. Provisional Application Ser. No. 61/017,218, filed Dec. 28, 2007, entitled “Method and Apparatus for Creating and Modifying Navigation Voice Syntax”, the disclosure of which is incorporated herein by reference in its entirety.

### BACKGROUND

A position-determining device may enable a user to determine the user's geographic position via one or more location-determining methods. Suitable location-determining methods include utilization of a satellite-based navigation system, utilization of data from cellular phone systems, and so on. A position-determining device may also communicate position-related data to a user, such as the user's current location or directions from the user's current location to another location. For example, if a user wishes to drive from the user's workplace to a particular restaurant, the user can request via the position-determining device driving directions from the user's workplace to the restaurant. The device can then provide the directions in a variety of formats, such as visually displaying the directions on a graphical display. A position-determining device can also provide the directions via audible turn-by-turn instructions to a user. Audible driving instructions are helpful in that the user does not need to switch the user's focus from the road to a graphical display in order to receive driving directions.

Current position-determining devices often use pre-recorded voices (PRVs) in providing audible driving instructions. However, current PRV implementations suffer from a number of drawbacks. First, syntax and vocabulary knowledge in many current PRV implementations is defined by operating software of the position-determining device, which inhibits the modification of existing and creation of new PRVs. Second, the rigid syntax and vocabulary defined within typical operating software inhibits the random selection of audio clips for a particular event for output by the position-determining device. Third, the rigid syntax and vocabulary defined within typical operating software inhibits the playback of audio clips in PRVs and other audio data at random times or intervals. Finally, current PRV implementations are difficult to use by third party developers since direction-related phrases are reused and there are few if any options for customization of audio output.

### SUMMARY

Techniques are described for enabling flexible and dynamic creation and/or modification of voice data for a position-determining device. In some embodiments, a voice package is provided that includes a language database and a plurality of audio files. The language database specifies appropriate syntax and vocabulary for information that is intended for audio output by a position-determining device. The audio files include words and/or phrases that may be accessed by the position-determining device to communicate the information via audible output.

This Summary is provided solely to introduce subject matter that is fully described in the Detailed Description and Drawings. Accordingly, the Summary should not be considered to describe essential features nor be used to determine scope of the claims.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example positioning system environment that is operable to provide flexible creation and modification of navigation voice data.

FIG. 2 is a flow diagram depicting a procedure in an example implementation for generating voice package data and loading the data on a position-determining device.

FIG. 3 is a flow diagram depicting a procedure in a specific example implementation for retrieving and arranging audio data for output by a position-determining device.

FIG. 4 is a flow diagram depicting a procedure in a specific example implementation for updating data in a voice package.

FIG. 5 is a flow diagram depicting a procedure in a specific example implementation for selecting a phrase from a plurality of available phrases to output information via audio output.

### DETAILED DESCRIPTION

### Overview

Techniques and processes for creation and modification of navigation voice data are described. In some embodiments, a voice package is provided that includes a language database and a plurality of audio files. The language database specifies appropriate syntax and vocabulary for information that is intended for audio output by a position-determining device. The audio files include words and/or phrases that may be accessed by the position-determining device to communicate the information via audible output. The audio files may be in any suitable format, such as .wav, .wma, .mp3, ogg, and so on.

Some embodiments also utilize a voice package toolkit to construct and/or customize one or more parts of a voice package. The toolkit may include one or more software modules and/or applications that reside on a position-determining device or other computing device. The toolkit may also include a test module that can be used by developers and/or end users to listen to various combinations of audio files that are generated from the syntax and/or vocabulary information in the voice package. The test kit enables developers and/or end users to test various navigation scenarios in a controlled environment and, in some embodiments, without an actual position-determining device (e.g., the test kit may reside on a computing device separate from a position-determining device).

In the following discussion, an example environment is first described that is operable to employ techniques and processes for creation and modification of navigation voice vocabulary and syntax discussed herein. Example processes are then described which may be employed in the exemplary environment, as well as in other environments without departing from the spirit and scope thereof. A discussion of the voice package toolkit is then presented, which is followed by one example of script that may utilized to implement various techniques and processes discussed herein. Finally, an example process is described for specifying criteria for selecting one or more phrases from a plurality of available phrases, the one or more phrases to be used to output information. Although the techniques and processes for creation and modification of navigation voice data are described in relation to a position-determining environment, it should be readily apparent that these techniques may be employed in a variety of different environments.

### Example Environment

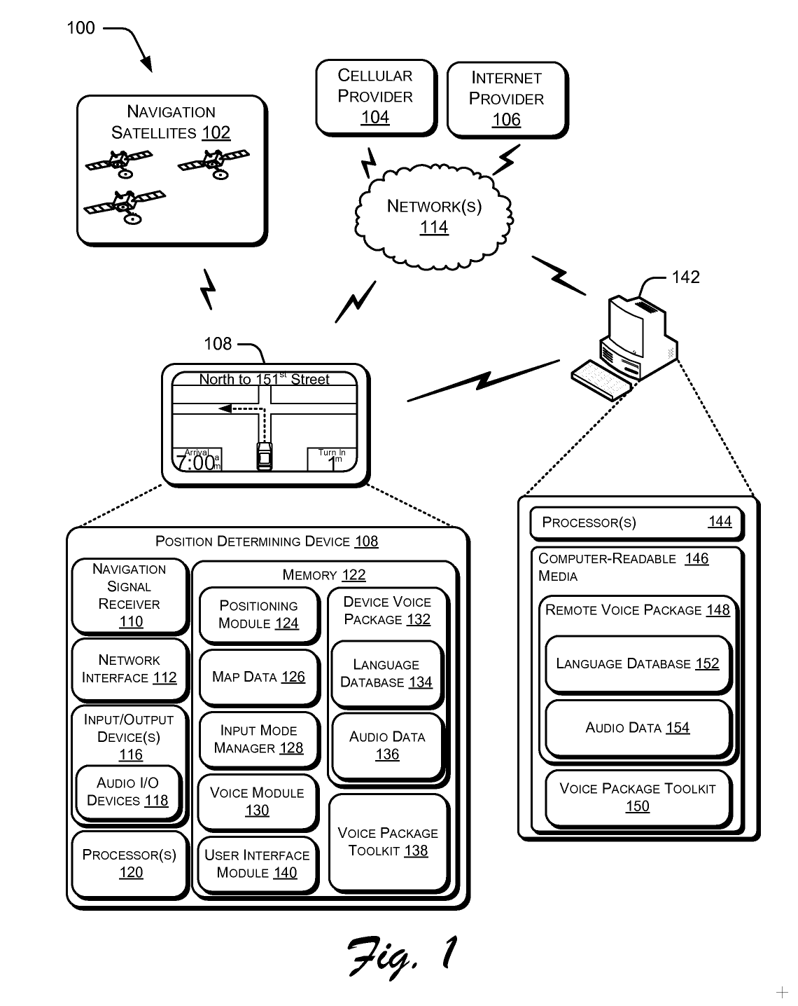

FIG. 1 illustrates an example positioning system environment 100 that is operable to perform processes and techniques discussed herein. The environment 100 may include any number of position data platforms and/or position data transmitters, such as navigation satellites 102. In the environment 100 of FIG. 1, the navigation satellites 102 are illustrated as including one or more respective antennas. The antennas each transmit respective signals that may include positioning information and navigation signals.

The environment 100 also includes a cellular provider 104 and an internet provider 106. The cellular provider 104 may provide cellular phone and/or data retrieval functionality to various aspects of the environment 100, and the internet provider 106 may provide network connectivity and/or data retrieval functionality to various aspects of the environment 100.

The environment 100 also includes a position-determining device 108, such as any type of mobile ground-based, marine-based and/or airborne-based device. In some embodiments, position-determining device 108 comprises a personal navigation device. The position-determining device 108 may implement various types of position-determining functionality which, for purposes of the following discussion, may relate to a variety of different navigation techniques and other techniques that may be supported by “knowing” one or more positions. For instance, position-determining functionality may be employed to provide location information, timing information, speed information, turn-by-turn driving instructions, and a variety of other navigation-related data. Accordingly, the position-determining device 108 may be configured in a variety of ways to perform a wide variety of functions. For example, the positioning-determining device 108 may be configured for vehicle navigation as illustrated, aerial navigation (e.g., for airplanes, helicopters), marine navigation, personal use (e.g., as a part of fitness-related equipment), and so forth. The position-determining device 108 may include a variety of devices to determine position using one or more of the techniques previously described.

The position-determining device 108 of FIG. 1 includes a navigation signal receiver 110 that is configured to receive navigation signals from one or more navigation-related devices (e.g., navigation satellites 102). The navigation signal receiver 110 may support a variety of different navigation-related platforms, such as global positioning system (GPS), GLONASS, Galileo, and so on. Although not expressly illustrated here, the position-determining device 108 may include one or more antennas for receiving various types of signals, such as navigation signals.

The position-determining device 108 also includes a network interface 112 that may enable the device to communicate with one or more networks, such as a network 114. The network 114 may include any suitable network, such as a local area network, a wide area network, the Internet, a satellite network, a cellular phone network, and so on. In one or more embodiments, the navigation signal receiver 110 may receive data and/or signals from the network 112 to determine a location (e.g., such as Assisted GPS, or “AGPS”). Thus, in one or more embodiments, the receiver 110 may be configured to include one or more network interface capabilities.

The position-determining device 108 also includes one or more input/output (I/O) device(s) 116 (e.g., a touch screen, buttons, wireless input device, data input, a screen, and so on). The input/output devices 116 include one or more audio I/O devices 118, such as a microphone, speakers, and so on. The various devices and modules of the position-determining device 108 are communicatively coupled to a processor 120 and a memory 122.

The processor 120 is not limited by the materials from which it is formed or the processing mechanisms employed therein, and as such, may be implemented via semiconductor(s) and/or transistors (e.g., electronic integrated circuits (ICs), programmable logic devices), and so forth. Additionally, although a single memory 122 is shown, a wide variety of types and combinations of computer-readable storage memory may be employed, such as random access memory (RAM), hard disk memory, removable medium memory (e.g., the memory 122 may be implemented via a slot that accepts a removable memory cartridge), and other types of computer-readable media. Although the components of the position-determining device 108 are illustrated separately, it should be apparent that these components may also be further divided and/or combined without departing from the spirit and scope thereof.

The position-determining device 108 is configured to receive signals and/or data transmitted by one or more position data platforms and/or position data transmitters, such as the navigation satellites 102. These signals are provided to the processor 120 for processing by a positioning module 124, which is storable in the memory 122 and is executable on the processor 120. The positioning module 124 is representative of functionality that determines a geographic location, such as by processing signals and/or data obtained from various platforms/transmitters to provide position-determining functionality, such as to determine location, speed, time, and so forth. The signals and/or data may include position-related data such as ranging signals, ephemerides, almanacs, and so on.

The positioning module 124 may be executed to use map data 126 stored in the memory 122 to generate navigation instructions (e.g., turn-by-turn instructions to a destination), show a current position on a map, and so on. The positioning module 124 may also be executed to provide other position-determining functionality, such as to determine a current speed, calculate an arrival time, and so on. A wide variety of other examples are also contemplated.

Also stored on memory 122 is an input mode manager 128 that may enable the position determining device 108 to operate in a variety of input modes (e.g., a touch input mode, an automated speech recognition mode, and so on).

Memory 122 also stores a voice module 130 that is configured to perform a variety of speech and/or voice-related functions for the position-determining device 108. A device voice package 132 is stored within memory 122 and includes a language database 134 and audio data 136. In various embodiments, the voice package 132 is separate from the operating software that is utilized by the position-determining device 108. The language database 134 includes syntax data and vocabulary data accessible to the position-determining device 108 for communicating audible information. The audio data 136 is a repository of audio files that can be accessed by various components of the position-determining device 108 to provide audio output functionality.

The memory 122 may optionally store a voice package toolkit 138 that provides functionality for the creation and/or customization of various aspects of the device voice package 132. A developer, end user, or any other entity may utilize the voice package toolkit 138 to add, delete, and/or change the data and/or configuration of the voice package. For example, a user may add audio files to the audio data 136 to be used in outputting navigation information via audio output from the position-determining device 108. A user may add audio files in a certain language or dialect that is not represented in the current assortment of audio files available from audio data 136. A user may also customize the particular syntax and/or vocabulary that the language database 134 currently provides. The voice package toolkit 138 provides an interface for the device voice package 132 contents and enables a variety of different users to modify the device voice package 132 contents without modifying the operating software of the position-determining device 108.

A user interface module 140 is stored on memory 122 and is configured to generate a variety of different graphical user interfaces (GUIs), such as GUIs designed for accepting physical interaction by a user with the position-determining device 108, GUIs designed to accept speech input from a user of the device, and so on. GUIs of the position-determining device 108 may also be configured to accept any combination of user input modes via a single GUI, such as a combination of tactile interaction with the device and audio input to the device.

The position-determining device 108 may also implement cellular phone functionality, such as by connecting to a cellular network provided by the cellular provider 104. Network connectivity (e.g., Internet access) may also be provided to the position-determining device 108 via the Internet provider 106. Using the Internet provider 106 and/or the cellular provider 104, the position-determining device 108 can retrieve maps, driving directions, system updates, the voice package 132, the voice package toolkit 138, and so on.

The positioning system environment 100 also includes a computing device 142. Although computing device 142 is illustrated here as a desktop computer, this is not intended to be limiting, and any suitable computing device may be utilized, such as a laptop computer, a digital media player, a PDA, and so on. The computing device 142 includes one or more processors 144 and computer-readable media 146. As with memory 122 of the position-determining device 108, the computer-readable media 146 can include a wide variety of types and combinations of computer-readable storage memory. Stored on the computer-readable media 146 are a variety of modules, including a remote voice package 148 and a voice package toolkit 150. Included in the remote voice package 148 are a language database 152 and audio data 154. The remote voice package 148 and the voice package toolkit 150 may include similar or the same data and functionality as described for device voice package 132 and voice package toolkit 138. Using the remote voice package 148 and the voice package toolkit 150 enables a voice package to be constructed and/or customized on a device remote from a position-determining device, and then loaded onto the position-determining device. As illustrated, the computing device 142 may communicate with the position-determining device 108 either directly or via the network(s) 114. Although not expressly illustrated here, a voice package toolkit may be implemented as a Web application that may be utilized to create and/or configure a voice package and download the voice package to the position-determining device.

Generally, any of the functions described herein may be implemented using software, firmware, hardware (e.g., fixed logic circuitry), manual processing, or a combination of these implementations. The terms “module” and “functionality” as used herein generally represent software, firmware, hardware or a combination thereof. In the case of a software implementation, for instance, the module represents executable instructions that perform specified tasks when executed on a processor, such as the processor 120 of the position-determining device 108 of FIG. 1. The program code may be stored in one or more computer readable media, an example of which is the memory 122 of the position-determining device 108 of FIG. 1. The techniques and processes for creation and modification of navigation voice vocabulary and syntax described herein are platform-independent, meaning that the techniques may be implemented on a variety of commercial computing platforms having a variety of processors.

### Example Procedures

The following discussion describes techniques and processes for creation and modification of navigation voice data that may be implemented utilizing the previously described systems and devices. Aspects of each of the procedures may be implemented in hardware, firmware, software or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and/or other example embodiments.

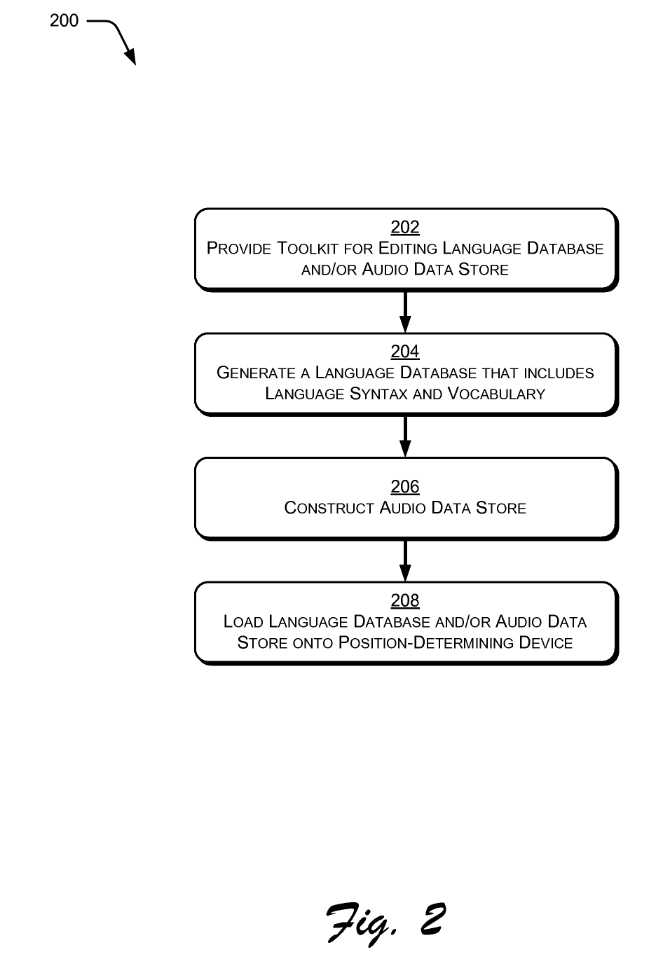

FIG. 2 illustrates a process 200 that is one example of a process for providing syntax information, vocabulary information, and audio data for a position-determining device. A voice package toolkit is provided for generating and/or configuring various aspects of a voice package (block 202). A language database is generated that includes language syntax information and vocabulary information (block 204). In some embodiments, syntax information includes data that specifies rules for arranging words in a particular language to construct phrases and/or sentences in that language. For example, particular syntax rules which apply for the English language may specify how English words can be arranged to communicate information. The English language is used for purposes of example only, and other embodiments may utilize any suitable language and/or dialect without departing from the spirit and scope of the claimed embodiments. Vocabulary information includes particular words and/or phrases that constitute a particular language, languages, and/or dialect.

The language and syntax provided by the language database may correspond to a plurality of entire utterances that may be audibly output by the position-determining device 108. “Utterance,” as used herein, refers to any phrase or other combination of words and/or numbers. In some embodiments, the language database may represent a plurality of expressions and one or more utterances corresponding to each expression. “Expression,” as used herein, refers to a concept that is desired to be communicated to the user. The expressions may correspond to a plurality of navigation-related expressions that may be communicated to the user based on the user's current position, a route traveled or initiated by the user or generated by the navigation device, based on the current position, and other navigation information, combinations thereof, and the like. However, the expressions may correspond to any information that may be audible communicated to the user.

For example, one navigation-related expression is that the user should turn right in <distance>. The language database may specify syntax and vocabulary for a plurality of utterances corresponding to this single expression. For example:

“Turn right in <distance>”
“Turn right, <distance>”
“In <distance>, turn right”
“<distance>, turn right”

Thus, by accessing the language database, the position-determining device 108 may identify the syntax and vocabulary for utterances and/or corresponding expressions. As is discussed in more detail herein, the language database-and the provided syntax and/or vocabulary-may be easily modified to provide any desired utterance having any syntax and vocabulary without impacting the operating system or other system instructions resident on the position-determining device 108.

An audio data store is constructed that includes a variety of audio data files (block 206). As mentioned above, the audio data files may be stored in any suitable format and may include words and/or phrases in a variety of different languages and dialects. In some embodiments, the language database and the audio data store are assembled into a voice package that may be downloaded or otherwise exported to one or more devices. The language database and the audio data store are loaded onto the device (block 208). Additionally or alternatively, the language database and/or the audio data store may be loaded or otherwise stored on a remote resource that is accessible to the device, such as computing device 142. Process 200 is typically implemented all or in part on a device (e.g., computing device 142) remote from the position-determining device. Alternatively and/or additionally, a voice package toolkit may reside on the position-determining device for configuring one or more aspects of a voice package.

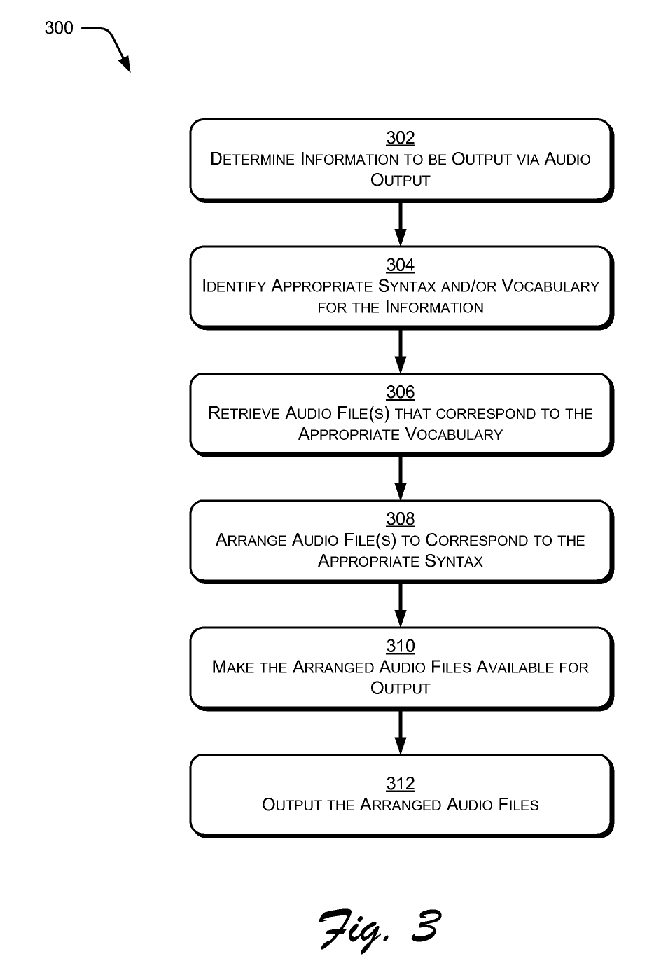

FIG. 3 illustrates a process 300 that is one example of a process for providing audible output of navigation-related information. Information is determined that is to be output via audio output by a position-determining device (block 302). In one example, a user of the position-determining device has requested travel directions (e.g., turn-by-turn driving instructions) from a first location to a second location. In this example, the position-determining device may determine that, to arrive at the second location from the first location, the user should be instructed to travel 2 miles west on Main Street. The position-determining device identifies the appropriate syntax and/or vocabulary for the information (block 304). Continuing the current example, the position-determining device may access a language database and determine, from the database, the correct syntax and/or vocabulary to communicate information to the user indicating that to reach the second location, the user should travel 2 miles west on Main Street.

One or more audio files are retrieved that correspond to the identified vocabulary for the information (block 306). In the current example, the vocabulary may include words and/or phrases such as “travel”, “drive for”, “two”, “Main”, “street”, and so on. Thus, audio files that correspond to these words and/or phrases are retrieved (e.g., from an audio data store, such as audio data 136). In some embodiments, a plurality of different audio files may be available that each correspond to a single word in the vocabulary. For example, the information “travel” may be associated with several different audio files, such as “drive”, “walk”, “ride”, and may also have a variety of different accents and/or voice inflections available for each word. Thus, when an audio file is requested for a single word in the vocabulary, a variety of different audio files may be available to fulfill the request. The audio data files are arranged according to the identified appropriate syntax (block 308). In the current example, the audio files are arranged to form a phrase such as “drive for two miles west on Main Street”, or “travel west on Main Street for two miles”, and so on. The arranged audio files are made available for output by the position-determining device (block 310). For example, one or more sentences and/or phrases that each correspond to a discrete travel instruction in a series of travel instructions may be stored in a buffer and provided (individually or as a group) to an audio output device when a travel instruction that corresponds to the sentences and/or phrases is relevant to a user's current position. In the current example, when the user is approaching a street where the user should make a right turn, an instruction such as “turn right in 100 meters” may be stored in a buffer and provided to an audio output device. The arranged audio files are output by the position-determining device (block 312).

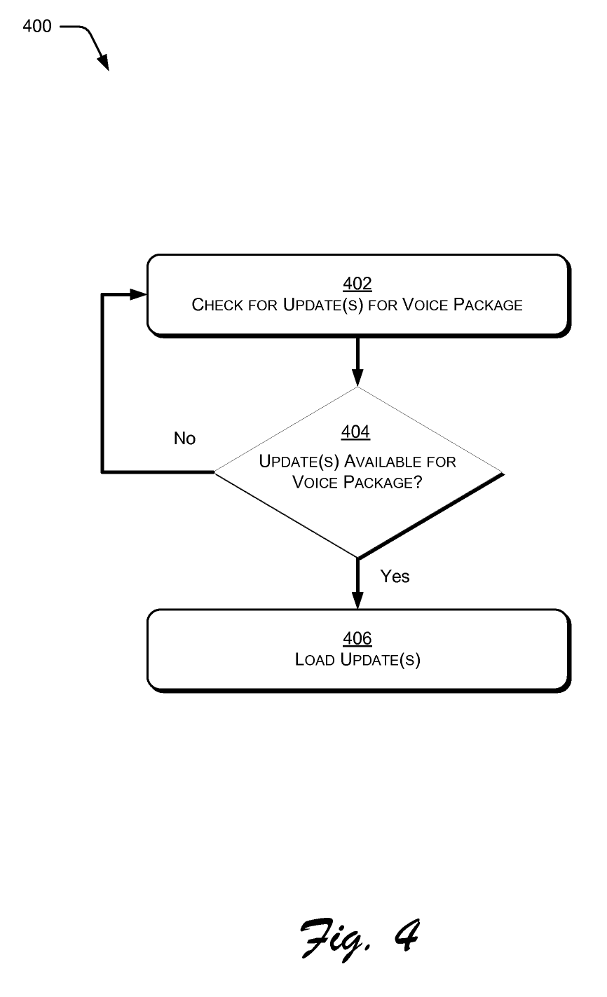

FIG. 4 illustrates a process 400 that is one example of a process for updating one or more aspects of a voice package (e.g., a language database, an audio data store, and so on). The process checks to see if one or more updates are available for a voice package (block 402). If it is determined that one or more updates are available for the voice package (block 404), the one or more updates are loaded onto a voice package on a position-determining device (block 406). If it is determined that no updates are currently available for the voice package (block 404), the process returns to block 402. Updates for a voice package may be created by a software and/or hardware developer, and may also be created by an end user. Updates may include updated syntax and/or vocabulary information, and may also include new and/or edited audio files. One or more operations in the process 400 may be implemented by a voice package toolkit.

### The Voice Package Toolkit

As discussed above, some embodiments may utilize a voice package toolkit to construct and/or customize one or more parts of a voice package. In some example implementations, a voice package toolkit may include and/or utilize a scripting language to create and/or customize one or more portions of the voice package without affecting a change in the operating software used by a position-determining device. For example, the toolkit may process a script written in the scripting language to form at least a portion of the voice package (e.g., the language database). The scripting language and associated scripts may be separate from the voice package and/or comprise a portion of the voice package. The voice package, database, and/or associated audio data may be dynamically updated at any time by utilizing the toolkit, other software, or manual methods.

The voice package toolkit may also include a command line utility to process the script and build the voice package, including the database and associated audio data. A test suite may also be included for testing the phrases represented by the audio data without requiring a position-determining device. This may allow a developer or other user to hear the various combinations of audio files that they have used. In at least one embodiment, a command line utility may concatenate the audio files for each phrase into one audio file. Additionally or alternatively, a GUI application may assemble the audio files and play them for one or more phrases.

### Example Script

The following is one example of script that may be used in one or more embodiments to define syntax and vocabulary for various utterances:

```
<expression = VPM_IN_DST_BOARD_FERRY>
    <utterance entry pct = 90> in {dist1} board ferry</entry>
    <utterance entry pct = 10> board the ferry in {dist2}</entry>
</expression >
<expression = VPM_TURN_RIGHT_IN_DST>
    <utterance entry pct = 60> turn right in {dist1}</entry>
    <utterance entry pct = 20> in {dist1} turn right </entry>
    <utterance entry pct = 10> turn right {dist1}</entry>
    <utterance entry pct = 10> {dist1} turn right </entry>
</expression >
< expression =
VPM_DRIVE_DST_THEN_ENTER_ROUNDABOUT>
    < utterance entry> drive {dist1} then enter roundabout</entry>
</expression >
<distance = dist1>
    <units = feet>
        <nmbr = 100>
            <entry> one hundred feet</entry>
        </nmbr>
        <nmbr = 200>
            <entry pct = 75> two hundred feet</entry>
            <entry pct = 25> two_hundred feet2</entry>
        </nmbr>
        similar for rest of numbers
    </units>
    <units = yards>
        same as above
    </units>
    <units = miles>
        same as above
    </units>
    <units = meters>
        same as above
    </units>
    <units = kilometers>
        same as above
    </units>
</distance>
<distance = dist2>
    same as above
</distance>
```

The individual words listed in the section above (such as ‘in’, ‘board’, and ‘ferry’ in the first entry) are the filenames for audio files (in any suitable file format), <expression> is a tag for an expression identified by the position-determining device 108, and <utterance entry> is a tag for an utterance. The above script is provided as an example only, and embodiments of the present invention may employ alternative scripts and databases—e.g., such as non-hierarchical scripts and databases that do not associate utterances to expressions.

In some embodiments, the voice package toolkit may read the contents of the script and create a language database (such as a table, listing, .vpm file, and so on) which specifies which audio files should be played for any given event and the order in which the audio files should be played. The language database and associated audio data (such as the audio files) may be transferred to a position-determining device for use using wired or wireless connections, including connections through a network such as the Internet. However, in some embodiments, the voice package toolkit and voice package may be resident on the position-determining device such that a user may change the voice syntax and other voice package data without accessing an external or separate computing device. When the operating software executed by the position-determining device needs to play an audible instruction or other utterance (e.g., phrase), it accesses the voice package to identify which audio files should be used and the order in which the audio files should be played. The identified audio files may then be played back in the specified order to the user.

For each phrase, different individual sets of audio files can be specified and given a use percentage associated with a number of times they should be played relative to each other. For example, for the Board Ferry instruction above, 90% of the time the first set will be played, but 10% of the time the second set will be played. For custom voices, this allows the voice to vary what is said. This keeps phrases such as a famous actor saying “I pity the fool who doesn't board the ferry” from getting old by allowing the user to only hear it 10% of the time. In some embodiments, the position-determining device can generate a random or pseudo-random number to select a particular audio file for playback instead, or in addition to, the percentage-based functionality discussed above.

For each phrase, a placeholder for distances can be used ({dist1}, {dist2}). This allows the database to specify the correct words to use for the distances in each phrase, since the words used for distances can depend on the other words in the phrase, or where it's used (e.g., changes in inflection).

Additionally or alternatively, for each phrase, a placeholder for variable content may be used ({dist1}, {dist2}, {ord1}). This allows the database to specify the correct words to use for that variable content in each phrase, since the words used for this variable content can depend on the other words in the phrase, or where it's used (e.g., changes in inflection).

To provide more creativity in the use of audio files, the voice package and corresponding audio data may include random phrases and non-navigation phrases. The use of these phrases may vary based on the particular implementation or configuration of the position-determining device. For example, on long route legs, a random phrase could be spoken. These might be jokes, quips, etc. “You're doing great!” or “{snoring} Huh? What? Sorry, must have dozed off, hopefully I didn't miss our turn.”

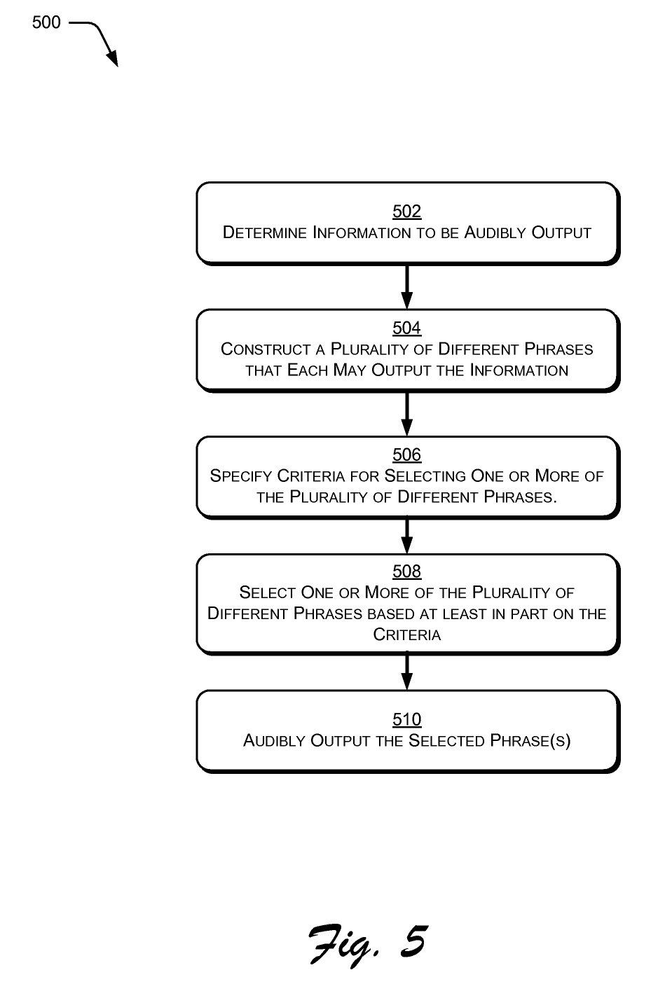

FIG. 5 illustrates a process 500 that is one example of a process for selecting a phrase from a plurality of available phrases to output information via audio output. Information is determined that is to be audibly output (e.g., by a position-determining device) (block 502). A plurality of different phrases are constructed that are each operable to output the determined information (block 504). For example, if the information includes the fact that a driver should turn left at First Street in 1 kilometer, several different phrases may be constructed to convey this information. One phrase might be “travel 1 kilometer and turn left at First Street”, whereas another phrase might be “turn left at First Street after traveling 1 kilometer”, and still another phrase might be “you should continue traveling for one kilometer and then make a left turn onto First Street”. As is readily apparent, a wide variety of different utterances (e.g., phrases) may be constructed to convey one or more expressions and the utterances may be pseudo-randomly selected for audible playback.

Criteria are then specified for selecting one or more of the plurality of different phrases (e.g., utterances) to convey the information (block 506). For example, and as mentioned above, each of the phrases may be assigned a percentage value or a phrase may be selected based on a randomly or pseudo-randomly generated number. In the current example, the first phrase may be provided 25% of the time, the second phrase 25% of the time, and the third phrase 50% of the time. One or more of the plurality of phrases is selected based at least in part on the specified criteria (block 508). The selected phrase(s) is/are audibly output (e.g., by the position-determining device) (block 510).

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A position-determining device comprising:
a navigation signal receiver operable to determine a current geographic location of the device;
a processor coupled with the navigation signal receiver;
an audio output device coupled with the processor;
computer-readable storage media operable to be accessed by the processor;
a voice package stored on the computer-readable storage media, the voice package comprising—
a language database to provide syntax and vocabulary for a plurality of entire utterances, and
an audio data store including one or more audio files corresponding to the vocabulary provided by the language database; and
computer-executable operating software, separate from the voice package, stored on the computer-readable storage media and executable by the processor to—
identify, in the language database, syntax and vocabulary for at least one of the entire utterances,
retrieve from the audio data store one or more of the audio files corresponding to the identified vocabulary,
construct a phrase using the identified syntax and the retrieved one or more audio files, and
output the constructed phrase through the audio output.

2. The device of claim 1, further including a network interface operable to be utilized by the processor to download the voice package from an external device.

3. The device of claim 2, wherein the operating software is executable by the processor to determine if one or more updates are available for the voice package and update at least a portion of the voice package through the network interface without making changes to the operating software.

4. The device of claim 1, wherein the operating software is executable by the processor to—
select an utterance based on the current geographic location of the device, and
identify, in the language database, syntax and vocabulary for the selected utterance.

5. The device of claim 4, wherein the operating software is executable by the processor to—
generate a navigation route based on the current geographic location of the device,
select one or more utterances based on the generated navigation route, and
identify, in the language database, syntax and vocabulary for the selected one or more utterances.

6. The device of claim 1, wherein the language database is dynamically configurable to include syntax information and vocabulary information for a plurality of languages.

7. The device of claim 1, wherein the language database includes a plurality of entire utterances for a single expression and the operating software is executable by the processor to pseudo-randomly select one of the entire utterances for the single expression.

8. The device of claim 7, wherein the language database specifies a use percentage for each of the utterances corresponding to the single expression and the utterance is pseudo-randomly selected based at least in part on the specified use percentages.

9. A position-determining device comprising:
a navigation signal receiver operable to determine a current geographic location of the device;
a processor coupled with the navigation signal receiver;
an audio output device coupled with the processor;
computer-readable storage media operable to be accessed by the processor; and
computer-executable instructions stored on the computer-readable storage media and executable by the processor to—
identify a plurality of utterances corresponding to a single expression,
pseudo-randomly select one of the identified utterances, and
output a representation of the selected utterance through the audio output.

10. The device of claim 9, wherein the computer-readable storage media includes a language database representing a plurality of single expressions and a plurality of associated utterances and the language database is accessed to identify the utterances corresponding to any one of the single expressions.

11. The device of claim 9, wherein the language database specifies a use percentage for each of the utterances corresponding to the single expression and the utterance is pseudo-randomly selected based at least in part on the specified use percentages.

12. The device of claim 9, wherein the computer-executable instructions include a randomizing function and the utterance is pseudo-randomly selected using the randomizing function.

13. The device of claim 9, wherein the computer-readable instructions are executable by the processor to identify the single expression based on the current geographic location of the device.

14. The device of claim 13, wherein the computer-readable instructions are executable by the processor to—
generate a navigation route based on the current geographic location of the device, and
identify the single expression based on the current geographic location of the device and the generated navigation route.

15. A method of selecting an utterance for output by a position-determining device, the method comprising:
identifying, in a language database resident on the position-determining device, a plurality of utterances corresponding to a single expression;
pseudo-randomly selecting one of the identified utterances; and
audibly outputting a representation of the selected utterance through an audio output associated with the position-determining device.

16. The method of claim 15, wherein the language database specifies a use percentage for each of the utterances corresponding to the single expression and the utterance is pseudo-randomly selected based at least in part on the specified use percentages.

17. The method of claim 15, wherein the utterance is pseudo-randomly selected using a randomizing function.

18. The method of claim 15, further including identifying the single expression based on a current geographic location of the position-determining device.

19. The method of claim 18, further including generating a navigation route and identifying the single expression based on the current geographic location of the device and the generated navigation route.

20. One or more computer-readable storage media storing computer-executable instructions, the computer-executable instructions being executable on one or more processors to:
process a script to generate a language database that specifies syntax and vocabulary for a plurality of entire utterances to be audibly output by a position-determining device;
construct an audio data store that includes audio files corresponding to the vocabulary; and
make the language database and the audio data store available to be loaded onto the position-determining device as a voice package.

21. The computer-readable storage media of claim 20, wherein the audio data store comprises a plurality of audio files that correspond to one or more words in the vocabulary.

22. The computer-readable storage media of claim 20, wherein the computer-executable instructions are configured as a toolkit for execution by a computing device remote from the position-determining device.

23. The computer-readable storage media of claim 20, wherein the computer-executable instructions are further executable by the one or more processors to load the voice package on the position-determining device without changing operating software associated with the position-determining device.

24. The computer-readable storage media of claim 20, wherein the computer-executable instructions are further executable by the one or more processors to provide a command line utility to process the script and generate the language database.
